(19) United States
(12) Patent Application Publication
(10) Pub. No.: US 2014/0320995 A1
(43) Pub. Date: Oct. 30, 2014

(54) IMPLEMENTING DATA FREQUENCY AND DATA BITS PER SECTOR (BPS) CALIBRATION FOR NON-CIRCULAR DISK TRACKS

(71) Applicant: HGST NETHERLANDS B.V., Amsterdam (NL)

(72) Inventors: Abhishek Dhanda, San Jose, CA (US); Toshiki Hirano, San Jose, CA (US); Tetsuo Semba, San Jose, CA (US); Satoshi Yamamoto, San Jose, CA (US)

(73) Assignee: HGST Netherlands B.V., Amsterdam (NL)

(21) Appl. No.: 13/873,809

(22) Filed: Apr. 30, 2013

(51) Int. Cl. G11B 20/10

(52) U.S. Cl. CPC G11B 20/10222; G11B 20/10398
USPC 360/51

(57) ABSTRACT

A method, apparatus and a data storage device are provided for implementing data frequency and data bits per sector (BPS) calibration for data written on a recordable surface including non-circular disk tracks of a storage device. A sector based BPS profile is created for data sectors on the recordable surface. The sector based BPS profile is used for modifying a number of data clock cycles based upon longer or shorter data sectors; and data clock frequency is dynamically adjusted based upon velocity jitter.

### FIELD OF THE INVENTION

The present invention relates generally to the data storage field, and more particularly, relates to a method, apparatus and a data storage device for implementing data frequency and data bits per sector (BPS) calibration for data written on a recordable surface including non-circular disk tracks of a storage device.

### DESCRIPTION OF THE RELATED ART

Many data processing applications require long-term data storage and typically a high-degree of data integrity. Typically these needs are met by non-volatile data storage devices.

Non-volatile storage or persistent media can be provided by a variety of devices, most commonly, by direct access storage devices (DASDs), which also are referred to as hard disk drives (HDDs), and disk drives.

A need exists to provide improved data format efficiency with better utilization of sector spacing during data writes. Also a need exists to provide improved data reliability where some hard drives will be installed in an environment with external disturbances.

A need exists for an effective and efficient mechanism to implement enhanced data writing on a recordable surface of a storage device.

### SUMMARY OF THE INVENTION

Aspects of the embodiments are to provide a method, apparatus and a data storage device for implementing data frequency and data bits per sector (BPS) calibration for data written on a recordable surface including non-circular disk tracks of a storage device. Other important aspects are to provide such method, apparatus and data storage device substantially without negative effect and to overcome some of the disadvantages of prior art arrangements.

In brief, a method, apparatus and a data storage device are provided for implementing data frequency and data bits per sector (BPS) calibration for data written on a recordable surface including non-circular disk tracks of a storage device. A sector based BPS profile is created for data sectors on the recordable surface. Using the sector based BPS profile; a number of data clock cycles is increased or decreased for respective longer or shorter sectors. Data clock frequency is adjusted based upon velocity jitter.

### BRIEF DESCRIPTION OF THE DRAWINGS

The present invention together with the above aspects, features, and advantages may best be understood from the following detailed description of the embodiments illustrated in the drawings, wherein:

FIG. 1A is a block diagram representation illustrating a system for implementing data frequency and data bits per sector (BPS) calibration methods under external disturbance conditions for data written in non-circular disk tracks on a recordable surface of a storage device in accordance with an embodiment;

FIG. 1B schematically illustrates not to scale example data tracks and servo tracks, an example servo field format, example frequency error obtained from delay between servo timing marks (STMs) or STM-to-STM delay, and example phase error in sampled servo preamble field automatic gain control (AGC) waveform of the system of FIG. 1A in accordance with an embodiment;

FIG. 2 is a flow chart illustrating example operations for implementing a data bits per sector (BPS) calibration method with the system of FIG. 1A in accordance with embodiments;

FIGS. 3A, 3B, and 3C are example waveforms illustrating example prior art data write operation;

FIG. 4 is a flow chart illustrating example operations for implementing a dynamic clock/frequency adjustment calibration method with the system of FIG. 1A in accordance with embodiments;

FIGS. 5A, 5B, and 5C are example waveforms illustrating example prior art data write operation with impact of velocity jitter;

FIGS. 6A, 6B, and 6C are example processes generating non-uniform physical sectors system used in implementing data frequency and data bits per sector (BPS) calibration methods of the system of FIG. 1A in accordance with an embodiment;

FIGS. 7A, 7B, and 7C are further example processes generating non-uniform physical sectors system used in implementing data frequency and data bits per sector (BPS) calibration methods of the system of FIG. 1A in accordance with an embodiment;

FIGS. 8A, 8B and 8C are example waveforms illustrating example impact of unequal sectors with velocity correction circular tracks of FIG. 1B in accordance with embodiments;

FIGS. 9A, 9B and 9C are example waveforms illustrating example impact of unequal sectors due to virtual tracks in accordance with embodiments;

FIG. 10 is a flow chart illustrating example operations for implementing sector size information in an enhanced data bits per sector (BPS) calibration method of the system of FIG. 1A in accordance with embodiments;

FIG. 11 is a flow chart illustrating example operations for implementing an enhanced dynamic clock/frequency adjustment calibration method of the system of FIG. 1A in accordance with embodiments;

FIGS. 12A, 12B and 12C are example waveforms illustrating example impact of unequal sectors due to virtual tracks of FIG. 1B in accordance with embodiments;

FIG. 13 is an example waveform illustrating example measured sector timings dependent on pure velocity error in accordance with embodiments;

FIG. 14 is an example waveform illustrating example measured sector timings dependent on pure written in error in accordance with embodiments;

FIGS. 15A, and 15B illustrate example relation between servo track profile, VCM current and timing for implementing data frequency and data bits per inch (BPI) calibration methods under external disturbance conditions in the system of FIG. 1A in accordance with embodiments; and

FIG. 16 is a block diagram illustrating a computer program product in accordance with embodiments.

### DETAILED DESCRIPTION OF THE EMBODIMENTS

In the following detailed description of embodiments, reference is made to the accompanying drawings, which illustrate example embodiments by which the invention may be practiced. It is to be understood that other embodiments may be utilized and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the embodiments, methods are provided for efficiently providing data frequency and data bits per sector (BPS) calibration under external disturbance conditions for data written on a recordable surface including non-circular disk tracks of a storage device, such as a hard disk drive.

In accordance with features of the embodiments, both improved data format efficiency with better utilization of sector spacing during data writes and improved data reliability where some hard drives will be installed in an environment with external disturbances are provided.

In accordance with features of the embodiments, a sector based BPS profile is created for data sectors for data written on a recordable surface including non-circular disk tracks of a storage device. For data written, a number of cycles is increased or decreased for longer or shorter data sectors and data frequency is adjusted based upon velocity jitter.

In accordance with features of the embodiments, a new method is provided to distinguish velocity versus written-in information using timing marks, such as servo timing mark delay between servo timing marks (STMs) or STM-to-STM delay and a voltage control module (VCM) profile to provide a radial modulation for data written in non-circular disk tracks on a recordable surface of a storage device.

In accordance with features of the embodiments, for sectors where sector spacing modulation cannot be completely utilized by BPS adjustment, such as where limited by resolution of data format specification, frequency can be relaxed to utilize sector to sector spacing modulation with BPS being relaxed as compared to a targeted specification for that track. Higher signal to noise ratio (SNR) and lower bit error rate (BER) expected for those sectors provides less sensitivity to adjacent track interference (ATI) or overrun. Also those sectors can be used to prioritize sector allocation under external disturbance conditions, such as various vibration conditions.

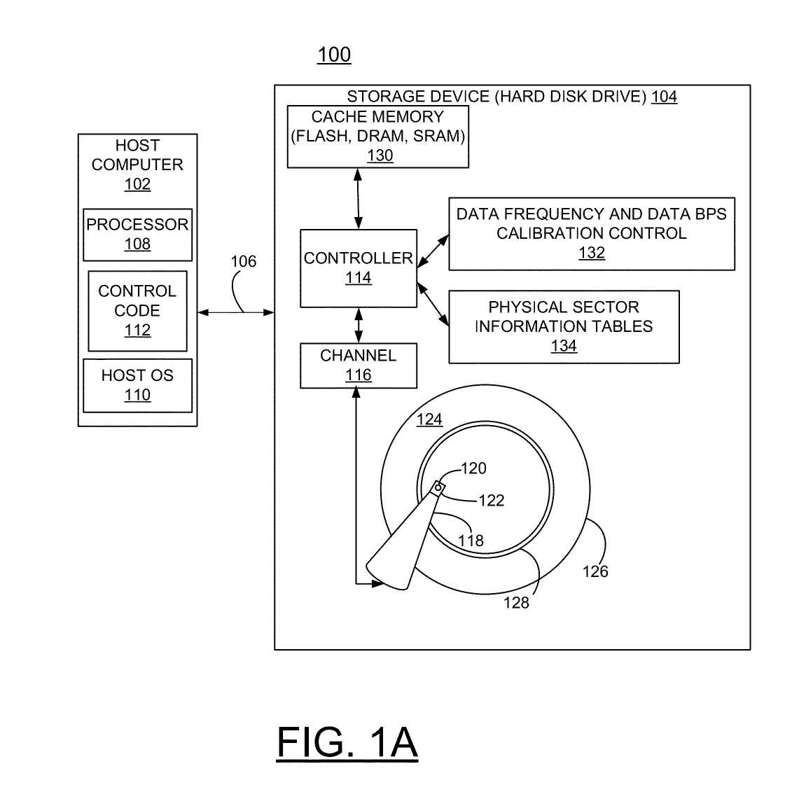

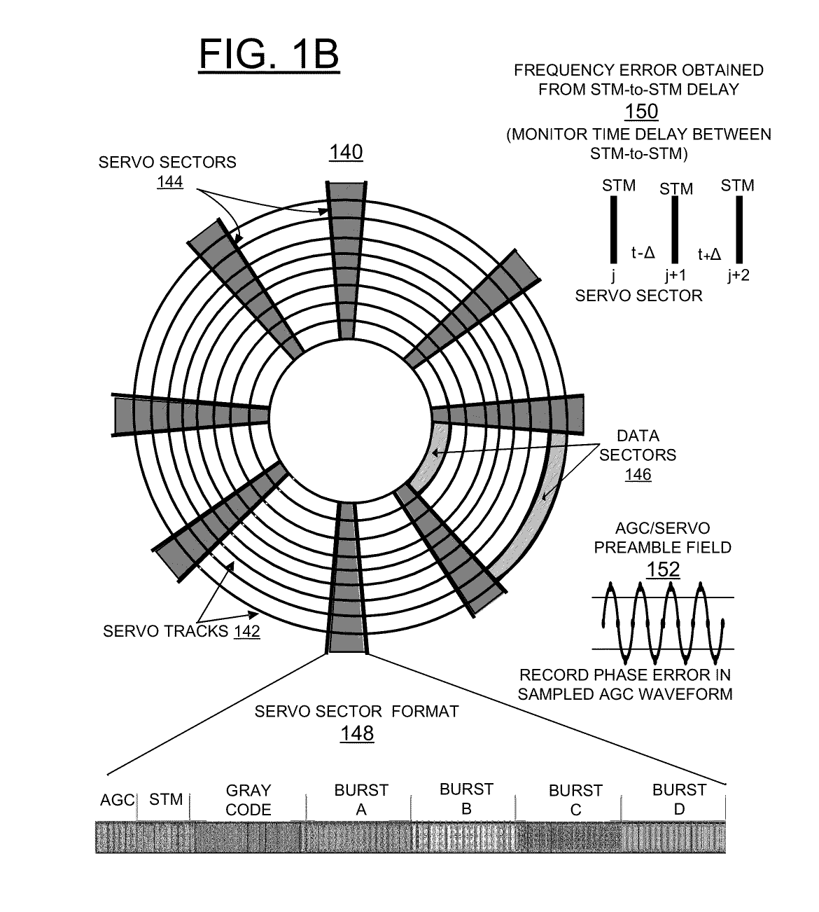

Having reference now to the drawings, in FIG. 1A, there is shown an example system generally designated by the reference character 100 for implementing data frequency and data bits per sector (BPS) calibration methods under external disturbance conditions for data written on a recordable surface including non-circular disk tracks of a storage device in accordance with an embodiment. System 100 includes a host computer 102, a storage device 104, such as a hard disk drive 104, and an interface 106 between the host computer 102 and the storage device 104.

As shown in FIG. 1A, host computer 102 includes a processor 108, a host operating system 110, and control code 112. The storage device or hard disk drive 104 includes a controller 114 coupled to a data channel 116. The storage device or hard disk drive 104 includes an arm 118 carrying a read/write head including a read element 120, and a write element 122. The hard disk drive (HDD) 104 includes, for example, a Shingled Disk Drive (SDD) to achieve high track density recording magnetic patterns of data on a writable disk surface 124 in overlapping circular tracks using shingled perpendicular magnetic recording (SMR).

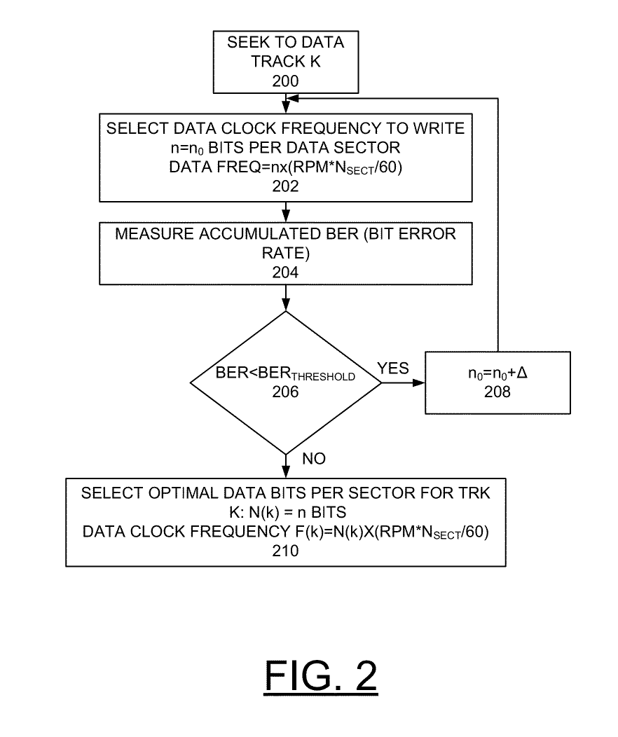

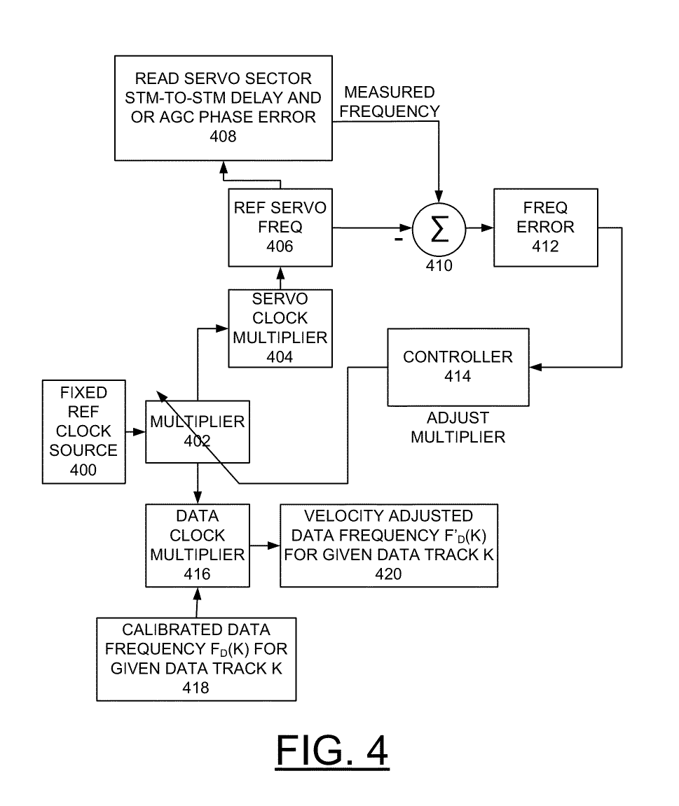

In operation, host operating system 110 in host computer 102 sends commands to hard disk drive 104. In response to the commands, hard disk drive 104 performs requested functions such as reading data, writing data, erasing data, and the like, on disk surface 124. The write element 122 writes magnetic patterns of data on the recordable or writable surface 124 of a disk 126. According to embodiments of the present invention, controller circuit 114 causes write element 122 to record magnetic patterns of data on a writable surface 124 of disk 122 in data tracks 128 implementing data frequency and data bits per sector (BPS) calibration methods, such as illustrated and described with respect to FIGS. 2, 4 10 and 11.

The controller circuit 114 positions the read head 120 and write head 122 over the recordable or writable surface 124 of the disk 126 using a servo loop locking to a predetermined servo positioning pattern, such as illustrated and described with respect to FIG. 1B.

In accordance with embodiments, system 100 includes a cache memory 130, for example, implemented with one or a combination of a flash memory, a dynamic random access memory (DRAM) and a static random access memory (SRAM). A data frequency and BPS calibration control 132 and physical sector information tables 134 in accordance with embodiments are provided with the controller 114 for implementing data frequency and data bits per sector (BPS) calibration methods for data written, for example, including data written under external disturbance conditions.

In accordance with embodiments, controller circuit 114 saves the BPS calibration information for use during write and read operations including, for example, saving BPS calibration information in physical sector information tables 134. A copy of these tables 134 can be written to a specific location on the disk to retain the information during a power off event.

Controller 114 can include various implementations, for example, fabricated with one or multiple integrated circuit dies. A digital video recorder (DVR), a set-top-box (STB), or various other computer system types are specific implementation of a host computer 102. While the control code 112 is shown in the host computer 102, and the controller 114 is shown in the hard disk drive 104, the control code 112 may reside in any suitable location, such as the hard disk drive 104 separate from host computer 102 and controller circuit 114 may reside in any suitable location, separate from hard disk drive 104, for example, in the host computer 102, and the like.

System 100 including the host computer 102 and the storage device or hard disk drive 104 is shown in simplified form sufficient for understanding the present invention. The illustrated host computer 102 together with the storage device or hard disk drive 104 is not intended to imply architectural or functional limitations. The present invention can be used with various other hardware implementations and systems

Referring to FIG. 1B, there is shown example data and servo layout generally designated by the reference character 140 including servo tracks 142, servo sectors 144, and data sectors 146. An example servo field format is shown generally designated by the reference character 148 including multiple fields, such as automatic gain control (AGC), servo timing mark (STM), gray code, and bursts A, B, C and D. An example frequency error signal generally designated by the reference character 150 is shown that is obtained from delay between servo timing marks (STMs) or STM-to-STM delay including servo sector STMs j, j+1, and j+2. An example phase error signal recorded in a sampled servo preamble field automatic gain control (AGC) waveform generally designated by the reference character 152 is shown.

Referring to FIG. 2, there are shown example operations for implementing a prior art data bits per sector (BPS) calibration method with the system 100, where BPS is constant for a track. As indicated in a block 200, example operations begin with seeking to data track K. As indicated in a block 202, data clock frequency is selected to write n=n₀ bits per data sector for all sectors in track K, where data clock frequency equals n×(RPM*N_{SECT}/60). Accumulated bit error rate (BER) is measured as indicated in a block 204. The measured BER is compared with a BER_{THRESHOLD} as indicated in a decision block 206. When the measured BER is less than the BER_{THRESHOLD}, then the number of n₀ bits per data sector is adjusted by a predetermined value Δ as indicated in a block 208, and the operations continue at block 202 with data clock frequency is selected to write n=n₀ bits per data sector. When the measured BER is greater than or equal to the BER_{THRESHOLD}, then an optimal sector size is selected of the number of n bits per data sector for data track K and the data clock frequency is set as indicated in a block 210.

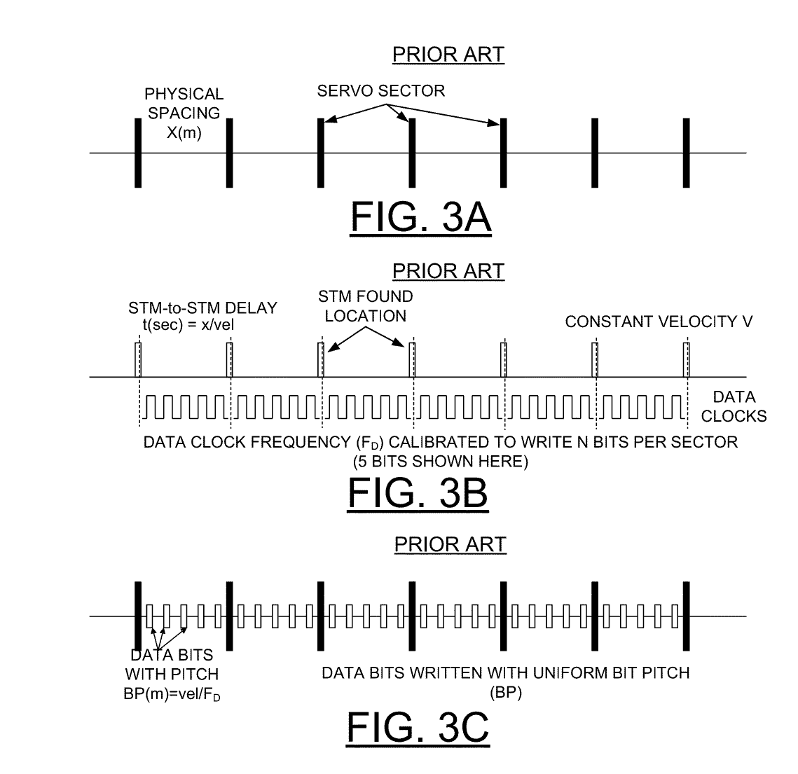

Referring to FIGS. 3A, 3B, and 3C, there are shown example waveforms illustrating example prior art data write operation with a physical spacing x(m) shown in FIG. 3A, measured STM-to-STM delay t(sec)=x/vel (velocity) with the data clock frequency selected to write n bits of data, and 5 bits shown in FIG. 3B, and physical data written with consistent bit pitch BP(m) shown in FIG. 3C.

Referring to FIG. 4, there are shown example operations for implementing a dynamic clock/frequency adjustment calibration method with the system 100 in accordance with embodiments. Velocity changes while following a data track can be due to spindle motor RPM variation (ω+Δω) or disk slip, where disk and spindle motor is not concentric (r+Δr) Velocity can be represented by:

vel=(ω+Δω)(r+Δr)

The data clock is adjusted to cancel velocity changes.

A fixed reference clock source as indicated in a block 400 provides an input to an adjustable multiplier 402. The adjustable multiplier 402 provides an input to a servo clock multiplier as indicated in a block 404. The servo clock multiplier is applied to a reference servo frequency source as indicated in a block 406 that provides an input to a read servo sector as indicated in a block 408 and an input to a negative input of a summation function as indicated in a block 410. The read servo sector provides a second input to the summation function 410, which applies a difference input to a frequency error function as indicated in a block 412. The frequency error function 412 provides a frequency error input to a controller function 414, which provides an adjust signal to the multiplier 402. The adjustable multiplier 402 provides an input to a data clock multiplier as indicated in a block 416. The data clock multiplier 416 receives an input for a given data track k: F_{D}(k) as indicated in a block 418. The output of servo clock multiplier is applied to provide an adjusted data frequency F′_{D}(k) for track k as indicated in a block 420.

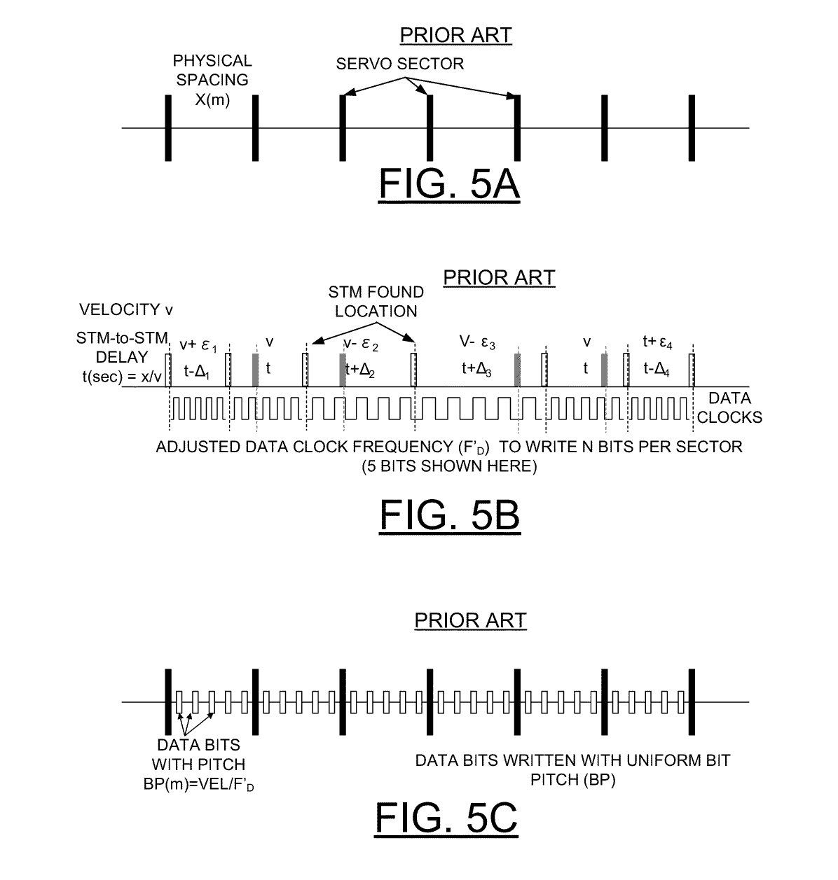

Referring to FIGS. 5A, 5B, and 5C, there are shown example waveforms illustrating example prior art data write operation with the impact of velocity jitter. The example prior art data write operation includes a physical spacing x(m) shown in FIG. 5A, measured STM-to-STM delay t(sec)=x/vel with the data clock frequency adjusted to write n bits of data, and 5 bits shown in FIG. 5B, and physical data bits written with consistent bit pitch BP(m) shown in FIG. 5C.

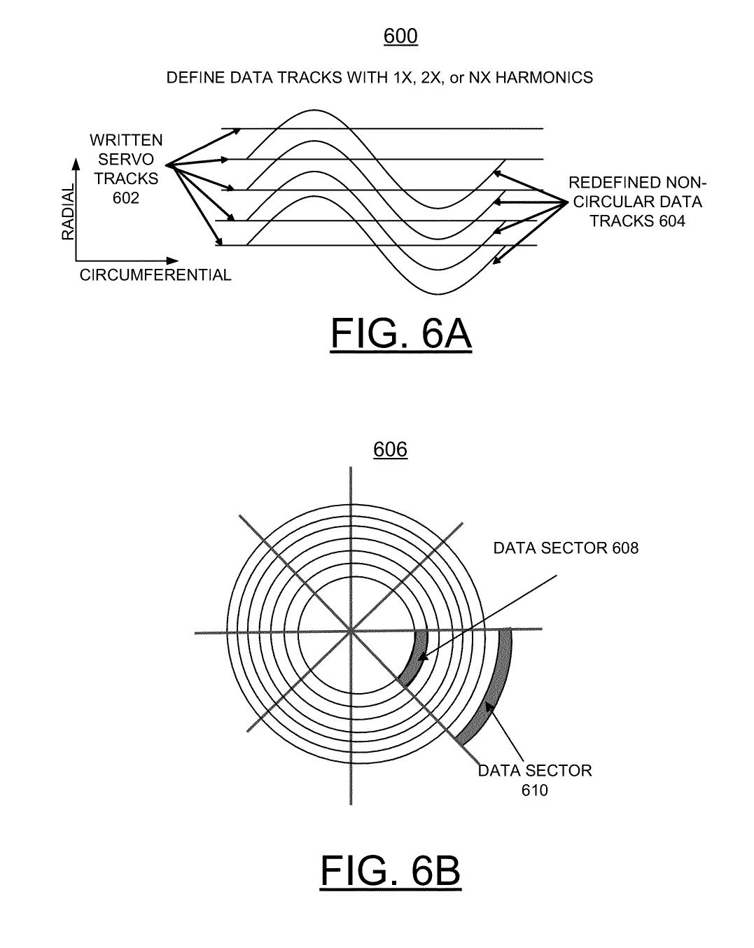

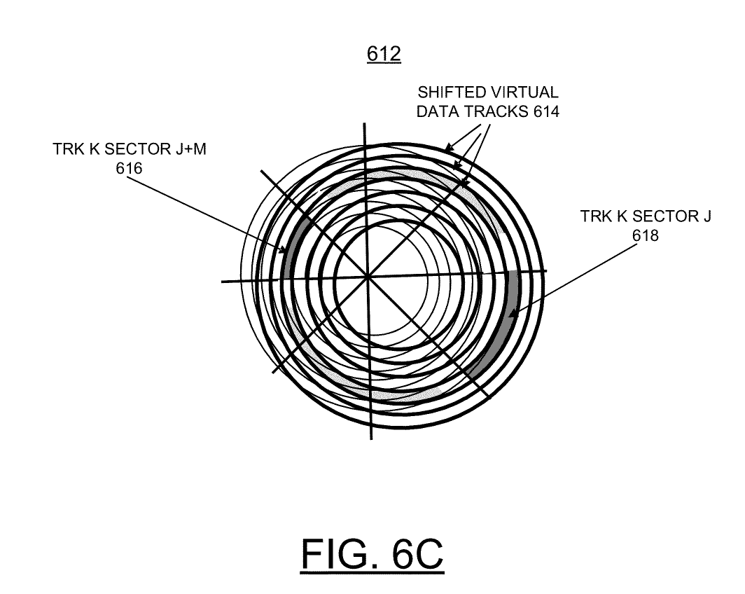

Referring to FIGS. 6A, 6B, and 6C, there are shown example processes generating non-uniform physical system used for implementing data frequency and data bits per sector (BPS) calibration methods of the system 100 in accordance with an embodiment. Data tracks are defined, for example, with 1×, 2×, or N× harmonics. In FIG. 6A, example written servo tracks 602 are shown together with redefined non-circular data tracks 604, with the example shown with 1× harmonics. In FIG. 6B, there is shown an example data and servo layout generally designated by the reference character 606 with concentric tracks written with perfect spacing for a given track and spacing varying with radius, for example, as shown for a data sector 608 near an inner diameter (ID) and data sector 610 near an outer diameter (OD). In FIG. 6C, there is shown an example data and servo layout generally designated by the reference character 612 with shifted virtual data tracks 614 written with different sector spacing for a given track or same track and spacing varying with radius, for example, as shown for a track K data sector J+M, 616 and a track K data sector J, 618.

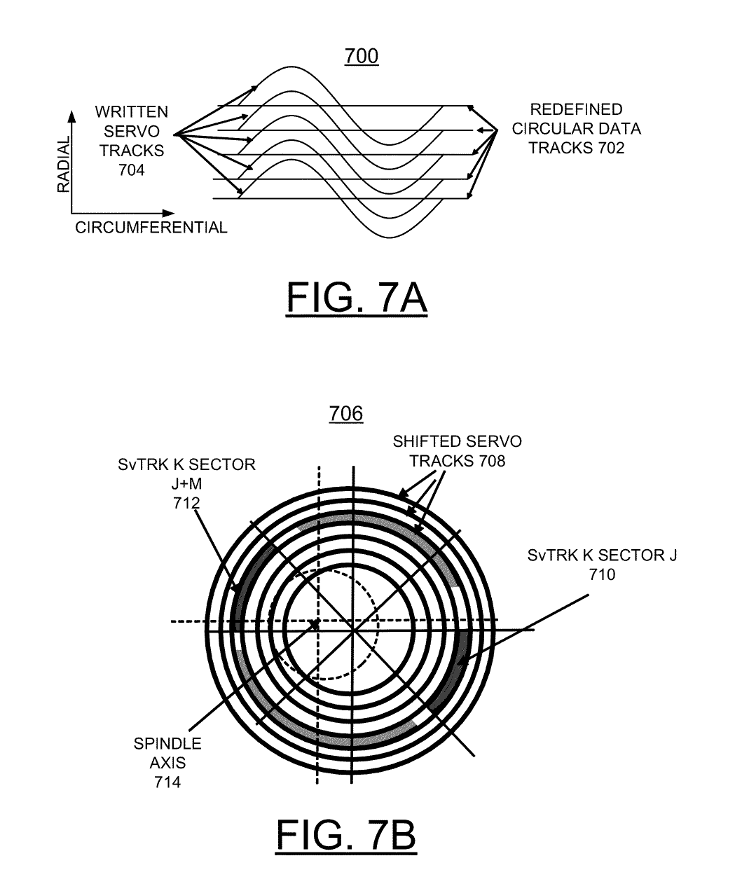

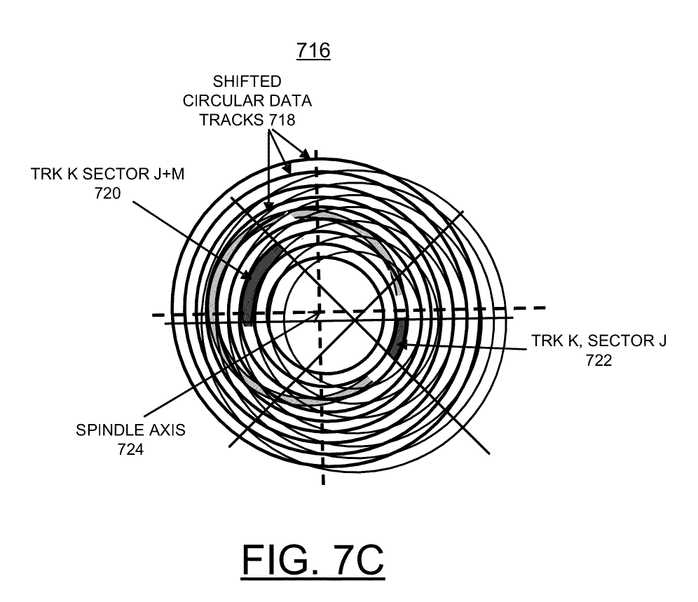

FIGS. 7A, 7B, and 7C are further example processes generating non-uniform physical sectors system used for implementing data frequency and data bits per sector (BPS) calibration methods of the system 100 in accordance with an embodiment. Servo tracks are written, for example, with 1×, 2×, or N× harmonics due to specific servo write operation selected. For example, eccentric servo tracks are generated by servo track write operation where disks are written externally and assembled in drive later on, which results in mismatch between spindle rotation center and disk center. In FIG. 6A, example written data tracks 702 are shown together with redefined non-circular data tracks 604, with the example underlying eccentric servo track shown with large 1× component due to eccentricity. In FIG. 7B, there is shown an example data and servo layout generally designated by the reference character 706 with shifted servo tracks 708 written with uniform sector spacing, for example, as shown for a servo track K, sector J, 710 and a servo track K, sector J+M, 712, with a spindle axis 714. In FIG. 7C, there is shown an example data and servo layout generally designated by the reference character 716 with shifted circular data tracks 718 written with different sector spacing for a given track or same track and spacing varying with radius, for example, as shown for a track K data sector J+M, 720 and a track K data sector J, 722.

In accordance with features of the embodiments, methods are provided for efficiently providing data frequency and data bits per sector (BPS) calibration for data written in data tracks, which are not concentric with servo tracks on a recordable surface 124 of a storage device 104, and the data sectors vary in length for the same track. Enhanced methods for BPS calibration and dynamic frequency adjustment are provided with enhanced efficiency over the illustrated respective methods of FIG. 2 and FIG. 4. For example, optimal BPS function of smallest sector in a give data track can provide non-optimal design for other sectors, as shown in FIG. 6C and FIG. 7C.

In accordance with features of the embodiments, methods are provided for identifying a velocity and sector size relation. For a virtual track where data tracks cross underlying circular servo tracks, such as illustrated in FIG. 6C, a single data track is located at different radial locations on a disk. Velocity and sector size change by same amount from one data sector to other on a give track as represented by the following:

Sector size x(j)=x₀+aₓ sin(αj+φ);

Velocity v(j)=ω(r₀+rₓ sin(αj+φ))=v₀+vₓ sin(αj+φ);

Sector-to-sector time t(j)=t₀(constant).

For a circular track where data tracks cross underlying non-circular servo tracks, such as illustrated in FIG. 7C, a single data track is located at a fixed radial location on a disk. Velocity is constant by sector size change from one data sector to other on a give track as represented by the following:

Sector size x(j)=x₀+aₓ sin(αj+φ);

Velocity v(j)=ωr₀=v₀;

Sector-to-sector time t(j)=t₀+tₓ sin(αj+φ).

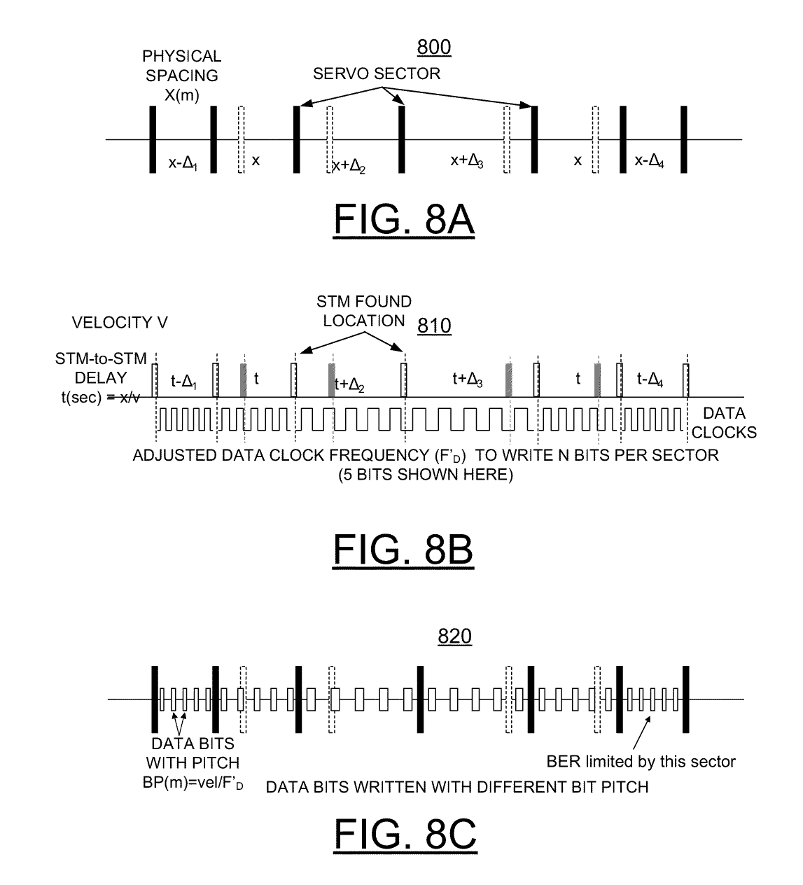

FIGS. 8A, 8B and 8C are example waveforms illustrating example impact of unequal sectors, such as illustrated in FIG. 7C with velocity correction circular tracks in accordance with embodiments, where

The illustrated example data write operation includes a physical spacing x(m) shown in FIG. 8A generally designated by the reference character 800. In FIG. 8B, there is shown measured time t(sec)=x/vel generally designated by the reference character 810 with the data clock frequency adjusted to write n bits of data, and 5 bits shown. In FIG. 8C, there are shown physical data bits with pitch BP generally designated by the reference character 820 with data bits written with different bit pitch and BER limited by a predefined sector, as shown.

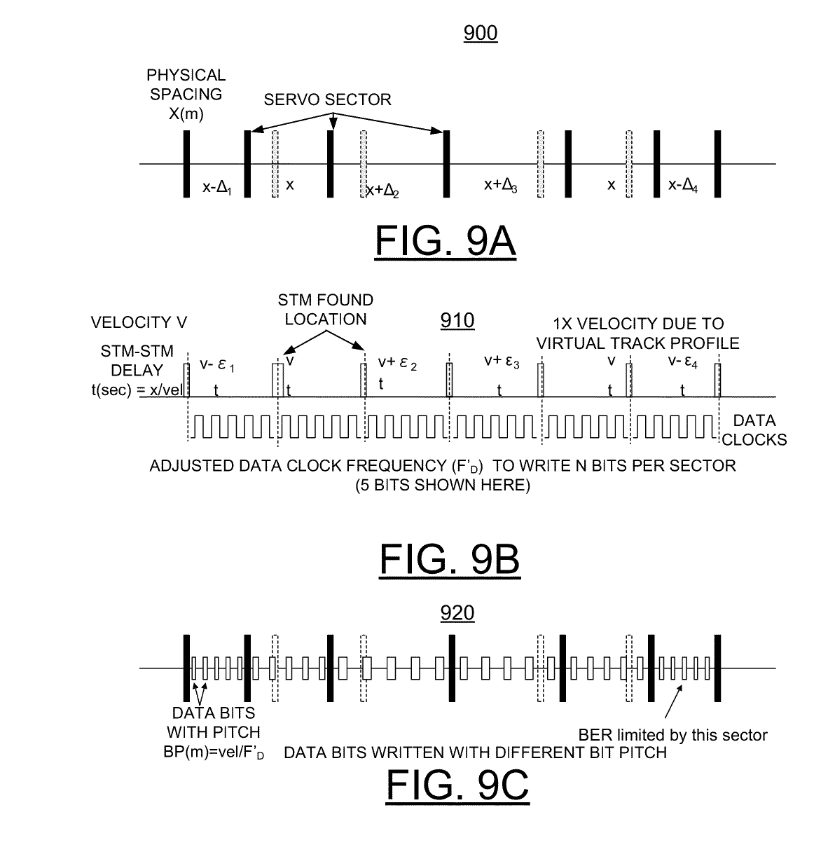

FIGS. 9A, 9B and 9C are example waveforms illustrating example impact of unequal sectors due to virtual tracks, such as illustrated in FIG. 6C in accordance with embodiments. The illustrated example data write operation includes a physical spacing x(m) shown in FIG. 9A generally designated by the reference character 900. In FIG. 9B, there is shown measured time t(sec)=x/vel generally designated by the reference character 910 with the data clock frequency adjusted to write n bits of data, and 5 bits shown. In FIG. 9C, there are shown physical data bits generally designated by the reference character 820 with data bits written with different bit pitch and BER limited by a predefined sector, as shown.

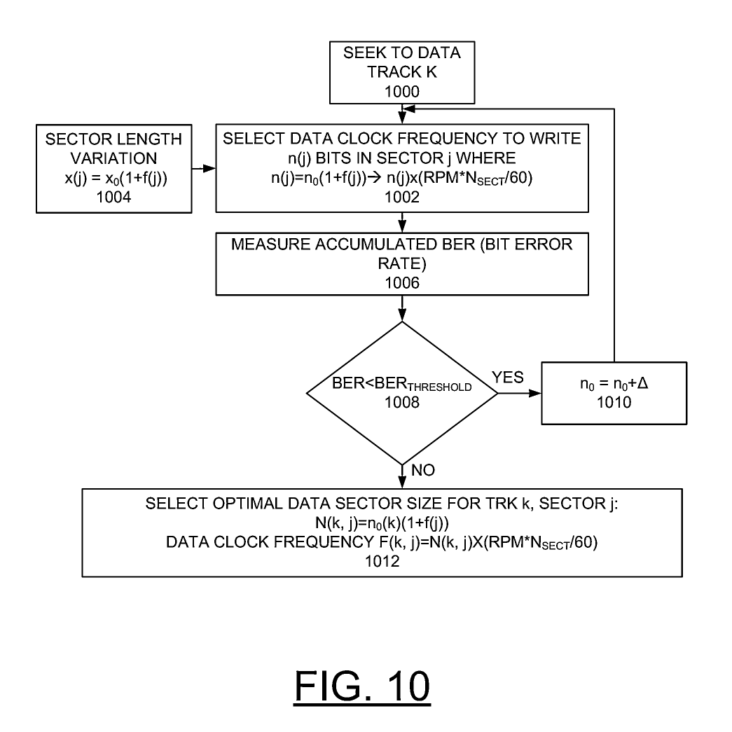

Referring now FIG. 10, there are shown example operations for implementing sector size information in a data bits per sector (BPS) calibration method of the system 100 in accordance with one preferred embodiment. As indicated in a block 1000, example operations begin with seeking to data track K. As indicated in a block 1002, data clock frequency is selected to write n(j)bits in sector j, where n(j)=n₀(1+f(j)), where data clock frequency equals n(j)×(RPM*N_{SECT}/60), where sector length variation x(j)=x₀ (1+f(j)) applied as indicated in a block 100. Accumulated bit error rate (BER) is measured as indicated in a block 1006. The measured BER is compared with a BER_{THRESHOLD} as indicated in a decision block 1008. When the measured BER is less than the BER_{THRESHOLD}, then the number of n₀ bits per data sector is adjusted by a predetermined value Δ as indicated in a block 1010, and the operations continue at block 1002 with data clock frequency is selected to write n(j)=n₀(1+f(j)) bits per data sector. When the measured BER is greater than or equal to the BER_{THRESHOLD}, then an optimal sector size is selected of the number of n bits per data sector for data track k, sector j and the data clock frequency is set as indicated in a block 1012 as represented by the following

Data Sector Size for track k, sector j equals: n(k,j)=n₀(k)(1+f(j));

Data clock frequency equals: F(k,j)=n(k,j)×(RPM*N_{SECT}/60).

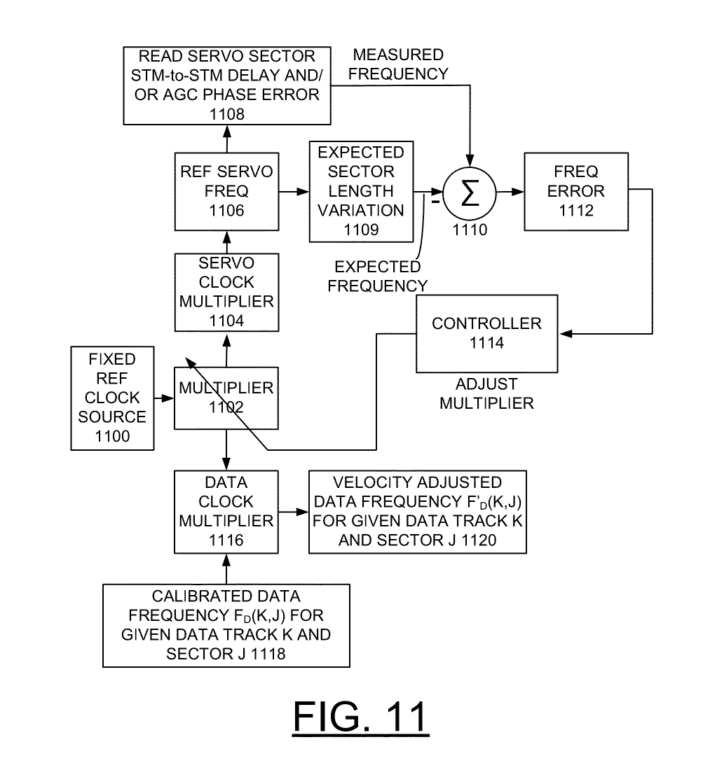

Referring now to FIG. 11, there are shown example operations for implementing a dynamic clock/frequency adjustment calibration method of the system of FIG. 1A in accordance with one preferred embodiment. The data clock is adjusted to cancel velocity changes. A fixed reference clock source as indicated in a block 1100 provides an input to an adjustable multiplier 1102. The adjustable multiplier 1102 provides an input to a servo clock multiplier as indicated in a block 1104. The servo clock multiplier 1104 is applied to a reference servo frequency source as indicated in a block 1106 that provides an input to a read servo sector as indicated in a block 1108 and is applied to an expected sector length variation function as indicated in a block 1109, which provides an input to a negative input of a summation function as indicated in a block 1110. The read servo sector 1108 provides a second input to the summation function 1110, which applies a difference input to a frequency error function as indicated in a block 1112. The frequency error function 1112 provides a frequency error input to a controller function 1114, which provides an adjust signal to the multiplier 1102. The adjustable multiplier 1102 provides an input to a data clock multiplier as indicated in a block 1116. The data clock multiplier 1116 receives an input for a given data track k and sector j: F_{D}(k, j) as indicated in a block 1118. The output of servo clock multiplier is applied to provide an adjusted data frequency F′_{D}(k,j) for track k and sector j as indicated in a block 1120.

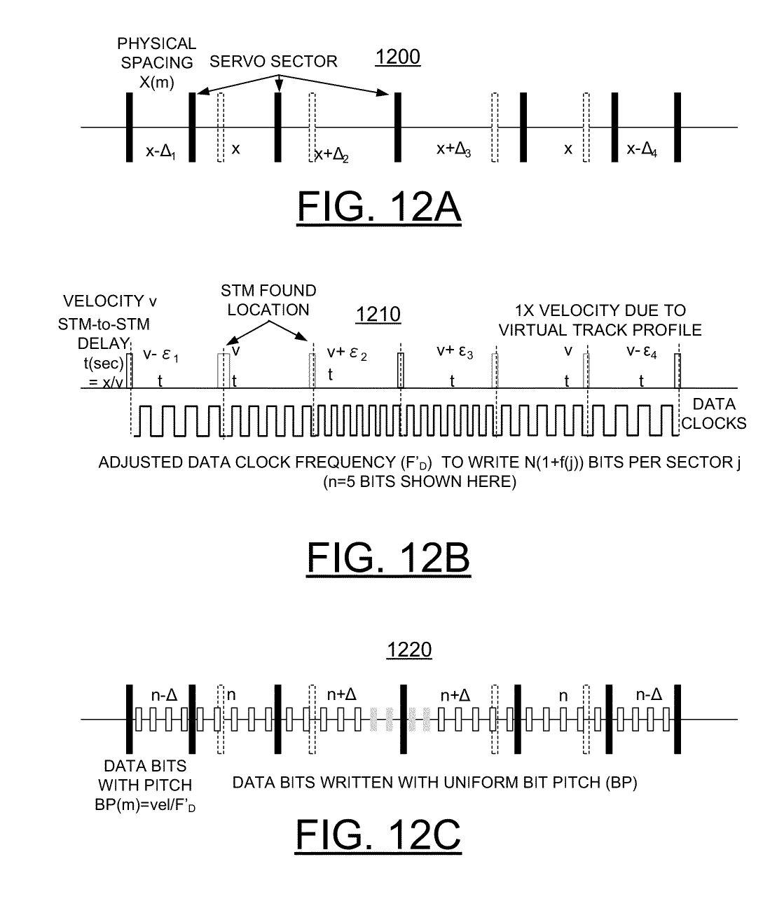

Referring now to FIGS. 12A, 12B and 12C, there are shown example waveforms illustrating example impact of unequal sectors due to virtual tracks of FIG. 1B in accordance with embodiments. The illustrated example data write operation includes a physical spacing x(m) shown in FIG. 12A generally designated by the reference character 1200. In FIG. 12B, there is shown STM-to-STM delay t(sec)=x/vel generally designated by the reference character 1210 with 1× velocity due to virtual track profile. The data clock frequency is adjusted to write n(1+f(j)) bits in sector j, with n=5 shown as an example. In FIG. 12C, there are shown physical data bits generally designated by the reference character 1220 with same bit pitch BP and BER same for all sectors, as shown.

In accordance with features of the embodiments, measured STM-to-STM delay depend on both velocity and written-in error, such as represented by:

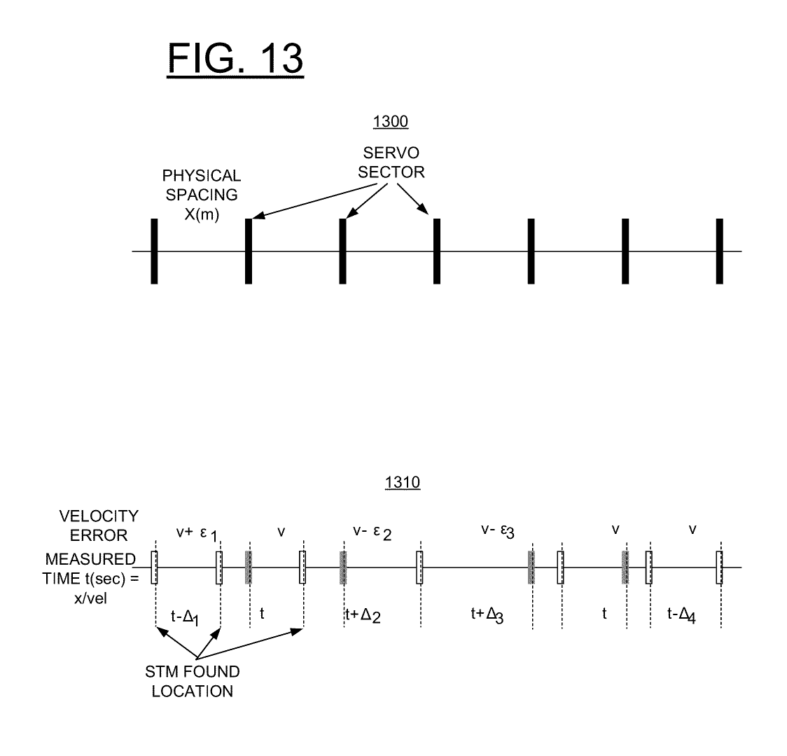

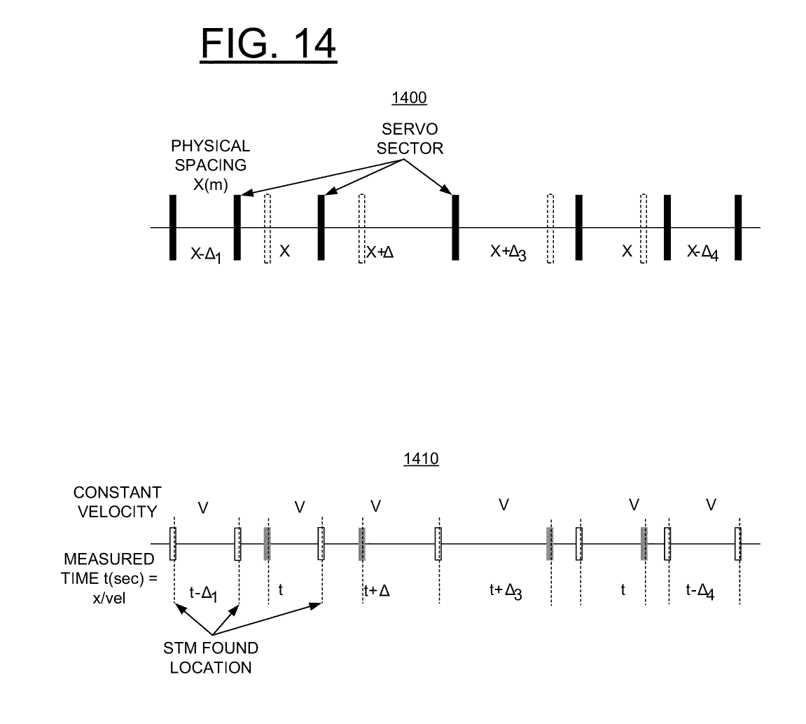

t=(x+Δx)/(v+Δv),

where t alone cannot be used to distinguish velocity vs. written in, for example, as illustrated in FIGS. 13 and 14, wherein both scenarios result in similar STM-to-STM delay variation

FIG. 13 there are shown example waveforms illustrating example measured sector timings dependent on pure velocity error in accordance with embodiments. In FIG. 13, there is shown measured time t(sec)=x/vel generally designated by the reference character 1400 with perfect velocity

FIG. 14, there are shown example waveforms illustrating example measured sector timings dependent on pure written in error in accordance with embodiments. In FIG. 14, there is shown measured time t(sec)=x/vel generally designated by the reference character 1400 with 1× velocity due to virtual track profile.

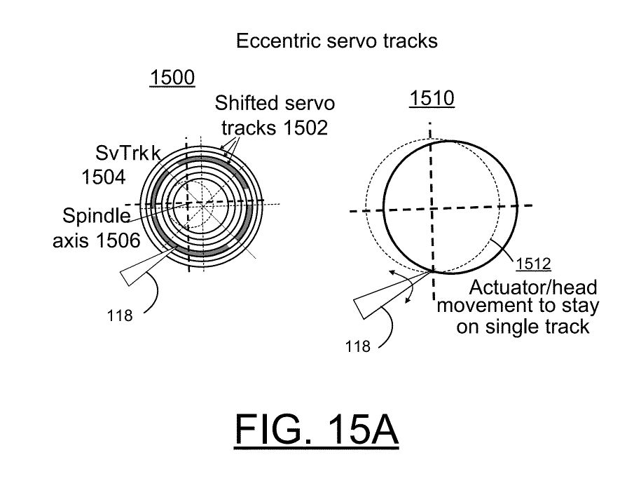

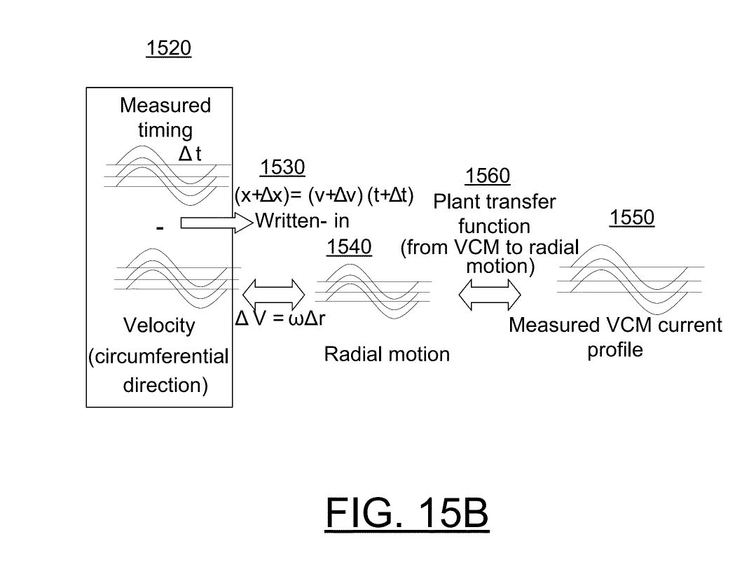

FIGS. 15A, and 15B illustrate an example relation between servo track profile, VCM current and timing for implementing data frequency and data bits per inch sector (BPS) calibration methods under external disturbance conditions in the system 100 in accordance with embodiments.

In FIG. 15A, there is shown an example servo layout generally designated by the reference character 1500 with shifted servo tracks 1502 and a servo track k, 1504 shown relative a spindle axis 1506 and the actuator 118. In FIG. 15B, there is shown an example shifted servo layout generally designated by the reference character 1510 with the actuator 118 and actuator/head movement shown in dotted line to stay on a single track generally designated by the reference character 1512.

In FIG. 15B, there is shown an example function providing measured timing Δv and velocity in a circumferential direction generally designated by the reference character 1520. Outputs generally designated by the reference character 1530 of function 1520 are indicated by (x+Δx)=(v+Δv)(t+Δt) Written-in and Δv=ωΔr, with a radial motion signal generally designated by the reference character 1540. An example waveform generally designated by the reference character 1550 illustrates measured VCM current profile. Next a plant transfer function generally designated by the reference character 1560 is provided from the radial motion signal 1540 and the measured VCM current profile 1550.

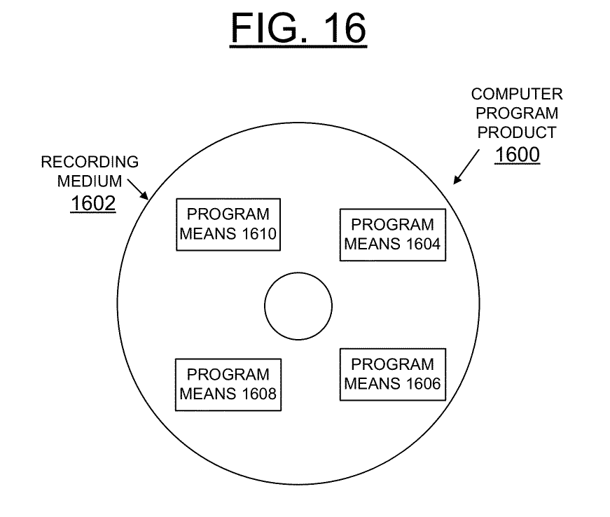

Referring now to FIG. 16, an article of manufacture or a computer program product 1600 is illustrated. The computer program product 1600 includes a computer readable recording medium 1602, such as, a floppy disk, a high capacity read only memory in the form of an optically read compact disk or CD-ROM, a tape, or another similar computer program product. Computer readable recording medium 1602 stores program means or control code 1604, 1606, 1608, 1610 on the medium 1602 for carrying out the calibration methods of the embodiments in the system 100 of FIG. 1A.

A sequence of program instructions or a logical assembly of one or more interrelated modules defined by the recorded program means or control code 1604, 1606, 1608, 1610, direct the system 100 for implementing data frequency and data bits per sector (BPS) calibration methods under external disturbance conditions for data written on the recordable surface including non-circular disk tracks of the embodiments.

While the present invention has been described with reference to the details of the embodiments shown in the drawing, these details are not intended to limit the scope of the invention as claimed in the appended claims.

1. A method for implementing data frequency and data bits per sector (BPS) calibration for data written on a recordable surface including non-circular disk tracks of a hard disk drive storage device comprising:
creating a sector based BPS profile for data sectors on the recordable surface;
using said sector based BPS profile, modifying a number of data clock cycles based upon longer or shorter data sectors; and
dynamically adjusting data clock frequency based upon velocity jitter; said data clock frequency dynamically adjusted to cancel velocity changes.

2. The method as recited in claim 1 wherein using said sector based BPS profile, modifying a number of data clock cycles based upon longer or shorter data sectors includes selecting a data clock frequency to write a selected number of bits in a given data sector, and measuring accumulated bit error rate (BER).

3. The method as recited in claim 2 includes comparing the measured BER with a threshold value, and responsive to the measured BER being less than the threshold value, increasing the selected number of bits by a predefined delta value and selecting the data clock frequency for the increased selected number of bits.

4. The method as recited in claim 3 includes responsive to the measured BER being equal to or greater than the threshold value, selecting a data sector size for the given data sector, and selecting the data clock frequency for the selected data sector size.

5. The method as recited in claim 1 wherein dynamically adjusting data clock frequency based upon velocity jitter includes identifying a frequency error, and responsive to identifying said frequency error, adjusting said data clock frequency.

6. The method as recited in claim 1 wherein dynamically adjusting data clock frequency based upon velocity jitter includes providing a reference clock to an adjustable multiplier, said adjustable multiplier providing an multiplied reference clock, using said multiplied reference clock, providing a reference servo frequency.

7. The method as recited in claim 6 includes using said provided reference servo frequency for identifying an expected sector length variation, and identifying a difference value between said expected sector length variation and a read servo sector.

8. The method as recited in claim 7 includes using said identified difference value for identifying a frequency error, and adjusting said adjustable multiplier, responsive to said identified frequency error.

9. The method as recited in claim 6 includes responsive to adjusting said adjustable multiplier, providing an input to a data clock multiplier for providing an adjusted data clock frequency for a given data track, and data sector.

10. An apparatus for implementing data frequency and data bits per sector (BPS) calibration for data written on a recordable surface including non-circular disk tracks of a hard disk drive storage device comprising:
a controller, said controller creating a sector based BPS profile for data sectors on the recordable surface;
said controller using said sector based BPS profile, modifying a number of data clock cycles based upon longer or shorter data sectors; and
said controller dynamically adjusting data clock frequency based upon velocity jitter; said data clock frequency dynamically adjusted to cancel velocity changes.

11. The apparatus as recited in claim 10, includes control code stored on a non-transitory computer readable medium, and wherein said controller uses said control code for implementing data frequency and BPS calibration.

12. The apparatus as recited in claim 10, wherein said controller using said sector based BPS profile, modifying a number of data clock cycles based upon longer or shorter data sectors includes said controller selecting a data clock frequency to write a selected number of bits in a given data sector, and measuring accumulated bit error rate (BER).

13. The apparatus as recited in claim 12, includes said controller comparing the measured BER with a threshold value, and responsive to the measured BER being less than the threshold value, increasing the selected number of bits by a predefined delta value and selecting the data clock frequency for the increased selected number of bits.

14. The apparatus as recited in claim 13, includes said controller, responsive to the measured BER being equal to or greater than the threshold value, selecting a data sector size for the given data sector, and selecting the data clock frequency for the selected data sector size.

15. The apparatus as recited in claim 10, wherein said controller dynamically adjusting data clock frequency based upon velocity jitter includes said controller identifying a frequency error, and responsive to identifying said frequency error, adjusting said data clock frequency.

16. The apparatus as recited in claim 10, wherein said controller dynamically adjusting data clock frequency based upon velocity jitter includes a fixed reference clock providing a reference clock to an adjustable multiplier, said adjustable multiplier providing an multiplied reference clock, applying said multiplied reference clock to a servo clock multiplier providing a reference servo frequency; using said reference servo frequency, identifying an expected sector length variation, identifying a difference between said expected sector length variation and a read servo sector; and identifying a frequency error.

17. The apparatus as recited in claim 16, includes said controller adjusting said adjustable multiplier, and said controller responsive to adjusting said adjustable multiplier, providing an input to a data clock multiplier for providing an adjusted data clock frequency for a given data track, and data sector.

18. A hard disk drive data storage device comprising:
at least one disk; said disk including a recordable surface, and said recordable surface including non-circular disk tracks;
a controller for implementing data frequency and data bits per sector (BPS) calibration for data written on said recordable surface
said controller creating a sector based BPS profile for data sectors on the recordable surface;
said controller using said sector based BPS profile, modifying a number of data clock cycles based upon longer or shorter data sectors; and
said controller dynamically adjusting data clock frequency based upon velocity jitter; said data clock frequency dynamically adjusted to cancel velocity changes.

19. The data storage device as recited in claim 18, includes control code stored on a non-transitory computer readable medium, and wherein said controller uses said control code for implementing data frequency and BPS calibration.

20. The data storage device as recited in claim 18, includes said controller reading a servo signal, identifying a frequency error, and responsive to identifying said frequency error, adjusting said data clock frequency.
